(19) United States
(12) Patent Application Publication
(10) Pub. No.: US 2021/0031893 A1
(43) Pub. Date: Feb. 4, 2021

(54) SELF-POWERED TROLLING MOTOR DEVICE

(71) Applicants: John Baldwin, Chatsworth, GA (US); Russell Springer, Chatsworth, GA (US)

(72) Inventors: John Baldwin, Chatsworth, GA (US); Russell Springer, Chatsworth, GA (US)

(21) Appl. No.: 16/526,041

(22) Filed: Jul. 30, 2019

(51) Int. Cl. B63H 20/00; B63H 21/17

(52) U.S. Cl. CPC B63H 20/007; B63H 2021/171; B63B 2209/18; B63H 21/17

(57) ABSTRACT

A self-powered trolling motor device including a shaft member including a motor element and a propeller element attached to the shaft member at a distal end and including at least one rechargeable battery and a control cover attached to the shaft member at a proximate end, the rechargeable battery having affixed thereto a plurality of solar panels on all sides of the battery, wherein the rechargeable battery and the affixed solar panels collectively form a self-powered unit for powering the device.

### FIELD OF THE INVENTION

Embodiments described herein generally relate to trolling motor devices, and more particularly to a self-powered trolling motor device.

### BACKGROUND OF THE INVENTION

Traditional trolling motors offer models that require expensive and heavy batteries to be used and finagled with during a necessary replacement. In addition, these models require cables and cords. These accessories with traditional trolling motors can and have become an unnecessary physical and financial burden on boat owners and anyone partaking in boat-related activities. Hence, it is desirable to provide a trolling motor for a boat that does not require any battery re-purchases, re-assembly or cables.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of a self-powered trolling motor device according to an embodiment of the present disclosure.

### SUMMARY OF THE INVENTION

Exemplary embodiments disclosed herein describe a self-powered trolling motor device including a shaft member having a motor element and a propeller element attached to the shaft member at a distal end and having at least one rechargeable battery and a control cover attached to the shaft member at a proximate end, the rechargeable battery having affixed thereto a plurality of solar panels on all sides of the battery, wherein the rechargeable battery and the affixed solar panels collectively form a self-powered unit for powering the device.

In some exemplary embodiments, the battery and the affixed solar panels have a cordless attachment to the device.

In some exemplary embodiments, the device includes one or more plugs to securely attach the rechargeable battery onto the device.

In some exemplary embodiments, the device includes a dual adjustable clamp and a motor bracket which are both affixed to the shaft member for securing the motor element, the propeller element, and the at least one rechargeable battery, including the affixed solar panels, to a front or back position of a boat.

In some exemplary embodiments, the device includes a pair of rechargeable batteries, each including a plurality of solar panels affixed thereto.

In some exemplary embodiments, the device includes a dual charger for charging the pair of rechargeable batteries.

### DETAILED DESCRIPTION

The present disclosure relates to a self-powered trolling motor device. The device is cordless and includes an attachable battery that is charged through affixed solar panels. The device is significantly more light-weight than traditional trolling motor models which creates an easy way for boaters to set up their trolling motors without hassle or intense physical or monetary expense.

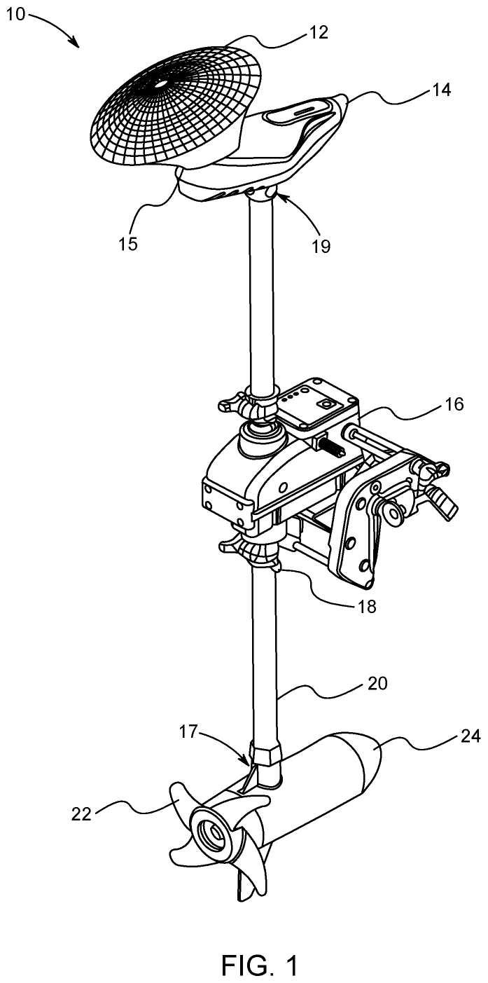

As illustrated in FIG. 1, the self-powered trolling motor device (“the device”) 10 includes a battery 12, a control cover 14, battery plugs 15, a motor bracket 16, an adjustable dual clamp 18, a shaft member 20, a propeller element 22 and a motor element 24. The propeller element and the motor element are attached to the shaft member at a distal end 17. The battery and the control cover are attached to the shaft member at a proximate end 19.

The battery 12 is rechargeable and includes solar panels affixed to all sides of the battery. The rechargeable battery and the affixed solar panels collectively form a self-powered unit which is used to power the device. The rechargeable battery and the affixed solar panels have a cordless attachment to the device. The battery may be a twenty-four volt (24 V) rechargeable battery and may be charged/re-charged from the power received from the solar panels.

In another exemplary embodiment, the device 10 may include a pair of rechargeable batteries, and a dual charger for charging the pair of rechargeable batteries. Each rechargeable battery may include a plurality of solar panels affixed thereto. The dual charger may receive power from the solar panels.

The control cover 14 may include the controls to operate the device 10. The controls to operate the device may include a hand tiller or remote control. The battery plugs 15 may hold the battery 12 on the device 10. The plugs may be any suitable hardware mechanism for fastening the battery to the device. The motor bracket 16 and the adjustable dual clamp 18 are attached to the shaft member 20 for securing the motor element 24, the battery 12, and the propeller element 22 to the front or back of a boat.

The shaft member 20 may provide the wires, including power and control signals, from the battery 12 and the control cover 14 to the propeller element 22 and the motor element 24. The propeller element 22 and the motor element 24 create propulsion in the boat. The propeller element includes blades that turn on the shaft, which is powered by the motor. The propeller element can have three, four, or five blades. Typically, the more blades on the propeller, the more propulsion can be achieved. While the motor element provides the power, the blades of the propeller element displace water to create the forces that move the boat forward.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A self-powered trolling motor device comprising:
a shaft member including a motor element and a propeller element attached to the shaft member at a distal end and including at least one rechargeable battery and a control cover attached to the shaft member at a proximate end, the rechargeable battery having affixed thereto a plurality of solar panels on all sides of the battery, wherein the rechargeable battery and the affixed solar panels collectively form a self-powered unit for powering the device.

2. The device of claim 1, wherein the at least one rechargeable battery and the affixed plurality of solar panels have a cordless attachment to the device.

3. The device of claim 1, further comprising one or more plugs to securely attach the rechargeable battery onto the device.

4. The device of claim 1, further comprising a dual adjustable clamp and a motor bracket both of which are affixed to the shaft member for securing the motor element, the propeller element, and the at least one rechargeable battery, including the affixed solar panels, to a front or back position of a boat.

5. The device of claim 1, further comprising a pair of rechargeable batteries, each including a plurality of solar panels affixed thereto.

6. The device of claim 5, further comprising a dual charger for charging the pair of rechargeable batteries.
